(19) United States
(12) Patent Application Publication
(10) Pub. No.: US 2002/0118843 A1
(43) Pub. Date: Aug. 29, 2002

(54) Vehicle audio adapter

(75) Inventors: Tsutomu Totani, Nagoya (JP); Yasuo Serikawa, Nagoyo (JP)

Correspondence Address: KODA & ANDROLIA, 2029 Century Park East, Suite 3850, Los Angeles, CA, 90067-3024, US

(73) Assignee: BEAT-SONIC CO., LTD.

(21) Appl. No.: 10/071,901

(22) Filed: Feb. 8, 2002

(30) Foreign Application Priority Data
Feb. 26, 2001 (JP) 2001-50684

(51) Int. Cl. H04B 3/00; H01R 33/945

(52) U.S. Cl. 381/77; 381/124; 439/577

(57) ABSTRACT

An audio adapter is used with a vehicle audio system including a power amplifier, a head unit serving as a tuner, and a plurality of loud speakers mounted in a vehicle compartment. The audio adapter includes a transformer provided for every one channel between a non-genuine head unit and the power amplifier when the head unit is replaced by the non-genuine head unit. The transformer matches an output impedance with an input impedance between the non-genuine head unit and the power amplifier. The transformer adjusts an output level of the non-genuine head unit to an input level of the power amplifier.

### BACKGROUND OF THE INVENTION

1. Field of the Invention

This invention relates to a vehicle audio adapter suitable for use in a super live sound system as a vehicle audio system in order that a genuine head unit of the system may be replaced by a commercially available non-genuine head unit.

2. Description of the Related Art

A super live sound system generally comprises a head unit 1, a power amplifier 2, seven to ten loud speakers 3-1 to 3-n, one or a plurality of dedicated connectors 4 and 5 connecting the head unit 1 to the power amplifier 2 and the like, and one or a plurality of dedicated connectors 6 connecting output of the power amplifier 2 to the loud speakers 3-1 to 3-n, as shown in FIG. 1.

The prior art has proposed several methods of replacing a genuine head unit with a commercially available non-genuine head unit and sold several adapters used for replacement of the head unit. However, all the conventional methods and adapters are insufficient. For example, a conventional super live sound system as shown in FIG. 2 uses a commercially available non-genuine deck 7 with an integrated power amplifier. The system further includes a plurality of extension cables 10. Each extension cable 10 has at one of two ends thereof a terminal, or a plug or plug receptacle each of which is connected to a speaker output of the deck 7. Each extension cable 10 has at the other end a connector 9 which is directly connected to a speaker connector 6. In the system, sound is produced from the loud speakers 3-1 to 3-n without use of the power amplifier 2.

Commercially available decks usually have a four channel speaker output system. Accordingly, when a commercially available four-channel deck is used in the foregoing super live sound system, a woofer cannot be operated. Furthermore, the head unit is usually embedded in a console provided in a car cabin, whereas the power amplifier 2 is disposed in a trunk in many cases. As a result, the length of each extension cable connecting the head unit to the power amplifier 2 is increased and accordingly, installation of the deck results in difficulty.

FIG. 3 illustrates a conventional adapter 12 provided between a commercially available non-genuine deck 11 having four-channel AUX outputs and the dedicated connector 4. The adapter 12 includes pin connectors 13 connected to the AUX outputs of the deck 11 and a connector 14 connected to the dedicated connector 4. The adapter 12 requires no long extension cables and allows a woofer to be operated. However, the adapter 12 requires the deck 11 to have four-channel AUX outputs. However, currently mainstream decks include an integrated power amplifier. This narrows a range of selection of new decks. Additionally, the adapter 12 has a bad matching with a required signal source impedance of the power amplifier 2, whereupon the performance of woofer is reduced.

### SUMMARY OF THE INVENTION

Therefore, an object of the present invention is to provide a vehicle audio adapter which can be used when the genuine head unit is replaced with a commercially available non-genuine head unit, and which can provide presence or realism in the super live sound system with the use of a genuine power amplifier.

The present invention provides an audio adapter used with a vehicle audio system including a power amplifier, a head unit serving as a tuner, and a plurality of loud speakers provided in a vehicle compartment. The audio adapter comprises a transformer provided for every one channel between a non-genuine head unit and the power amplifier when the head unit is replaced by the non-genuine head unit. The transformer matches an output impedance with an input impedance between the non-genuine head unit and the power amplifier. The transformer adjusts an output level of the non-genuine head unit to an input level of the power amplifier.

The foregoing audio adapter has a simple arrangement but can be used with a commercially available deck with an integrated power amplifier. Consequently, an appropriate level conversion and low signal source impedance can be ensured. Accordingly, the head unit in the super live sound system as the vehicle audio system can be replaced by a commercially available non-genuine deck. The head unit can further be replaced by latest audio equipment such as CD or MD. Furthermore, the super live sound system can provide presence or realism since the genuine power amplifier remains unchanged.

In a modified form, the loud speakers include first and second loud speakers including respective transformers having respective secondary windings connected in series or parallel with each other. The audio adapter further comprises an electric circuit for generating a mixed signal of a first loud speaker signal and a second loud speaker signal by connecting the secondary windings of the transformers of the first and second loud speakers in series or parallel with each other so that a center speaker signal and a woofer signal are generated.

In another modified form, the loud speakers include a first loud speaker and a second loud speaker. The audio adapter further comprises a transformer having a primary side including two windings and a secondary side including one winding, the two windings of the primary side serving as transformer inputs of the first and second loud speakers respectively, the winding of the secondary side serving as a mixed signal output of first and second loud speaker signals.

### BRIEF DESCRIPTION OF THE DRAWINGS

Other objects, features and advantages of the present invention will become clear upon reviewing the following description of an embodiment, made with reference to the accompanying drawings, in which:

FIG. 1 is a schematic block diagram showing an electrical arrangement of a super live sound system;

FIG. 2 is a schematic block diagram showing a conventional example using a commercially available non-genuine deck;

FIG. 3 is also a schematic block diagram showing another conventional example using a commercially available non-genuine deck;

FIG. 4 is a schematic block diagram showing an electrical arrangement of the a super live sound system using an audio adapter of one embodiment in accordance with the present invention;

FIG. 5 is a schematic electrical circuit diagram of a transformer integrated in the audio adapter;

FIG. 6 is a schematic electrical circuit diagram of another transformer integrated in the audio adapter; and

FIG. 7 is a schematic electrical circuit diagram of transformers used when a woofer signal is required as well as an audio signal.

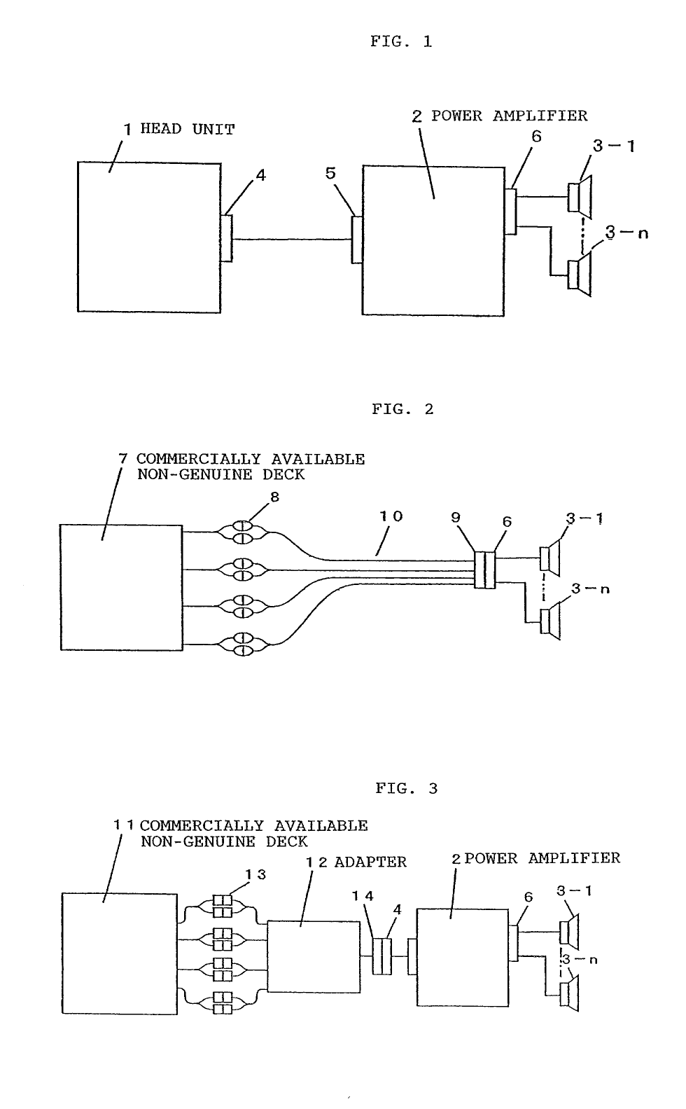

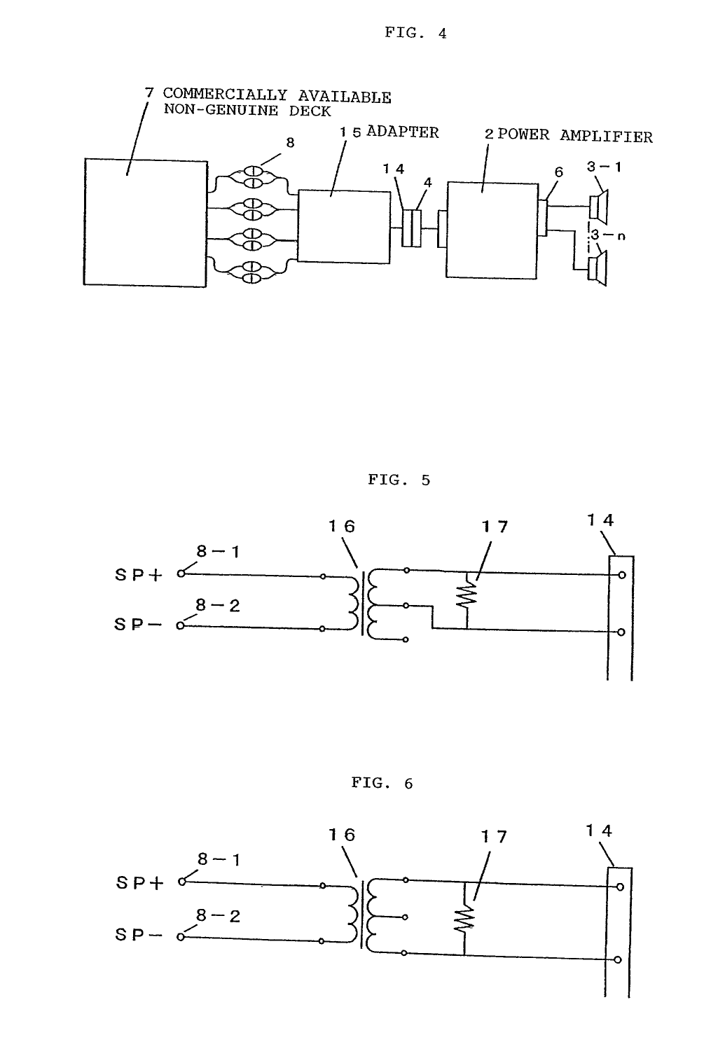

### DETAILED DESCRIPTION OF AN EMBODIMENT

One embodiment of the present invention will be described with reference to the accompanying drawings. Referring to FIG. 4, a super live sound system using the audio adapter of the embodiment is shown. The system includes a commercially available non-genuine deck 7 and four terminals 8, plugs or plug receptacles each of which is connected to a speaker output of the deck 7. The system further includes a vehicle audio adapter 15 having a connector 14 connected to the dedicated connector 4. The adapter 15 is provided between the deck 7 and the power amplifier 2. The audio adapter 15 converts the speaker output of the deck 7 to an output with a level suitable for input to the power amplifier 2. The audio adapter 15 is composed to sufficiently satisfy a signal source impedance the power amplifier 2 requires.

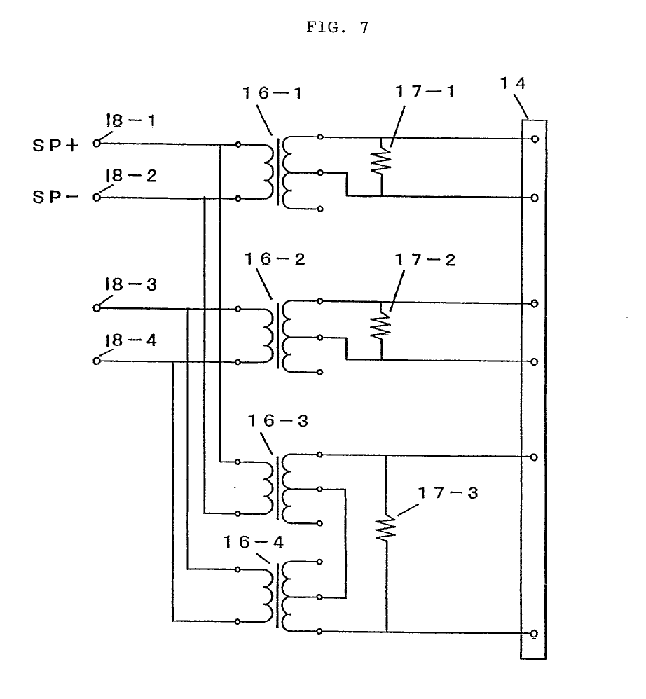

The operation of the super live sound system will now be described with reference to FIG. 5. FIG. 5 shows the arrangement of a transformer for one of four channels. Each one of the other three channels has the same arrangement as shown in FIG. 5. A terminal, plug or plug receptacle 8-1 is connected to a positive speaker output of the deck 7, and a terminal, plug or plug receptacle 8-2 is connected to a negative speaker output. An output of the deck 7 is connected via the terminals 8-1 and 8-2 to a transformer 16 integrated in the adapter 15. The transformer 16 has a winding ratio of 4.15:1 (0.5), a primary side impedance of 10 kΩ and a secondary side impedance of 600 Ω (150Ω). Parenthesized numerals denote values obtained when a secondary side center tap is used. For example, when an output of 25 W is produced by the deck 7, a speaker terminal voltage, that is, voltage delivered to the primary side of the transformer 16 is at 10 V. Voltage of 1.2 V is generated at the secondary side of the transformer 16. Consequently, the voltage level is substantially appropriate to be supplied into the power amplifier 2, and a signal source impedance is maintained at an appropriate level for the requirement.

A resistor 17 selects a resistance value thereof to adjust an input level to the power amplifier 2. The resistor 17 is not required when the adjustment of input level is unnecessary. Load is at 4Ω when output of 25 W is produced by the deck 7 although the speaker output of the deck 7 is at 10 V. When the resistor 17 is connected to the adapter 15, load is 10 kΩ and output power is 0.01 w.

FIG. 6 illustrates another arrangement of the adapter 15. A center tap of the secondary winding of the transformer 16 is not used when a required signal level of the power amplifier 2 is large.

FIG. 7 illustrates a case where the power amplifier 2 requires a woofer signal as well as four channel sound signals. A woofer signal is normally monaural, and a high-cut filter is integrated in the power amplifier 2. The woofer signal has the same AUX level as the other four channel sound signals. A rear left-hand loud speaker output of the deck 7 is supplied via the terminals 18-1 and 18-2 into the primary side of each of transformers 16-1 and 16-3. A rear right-hand loud speaker output of the deck 7 is supplied via the terminals 18-3 and 18-4 into the primary side of each of transformers 16-2 and 16-4. The secondary side output of each transformer 16-1 or 16-2 is connected to a corresponding terminal of the connector 14 as each channel output.

The secondary outputs of the transformers 16-3 and 16-4 are serially connected so that a signal indicative of the addition of the rear left-hand and rear right-hand outputs is generated at both ends of the secondary side output. The output of this signal is suitably adjusted by the resistor 17-3 to be connected as the woofer signal to the terminal of the connector 14 thereafter. Secondary side center taps of the transformers 16-3 and 16-4 are not used depending upon the cases in the same manner as described above with reference to FIG. 6.

According to the foregoing embodiment, the adapter 15 is provided between the commercially available deck 7 and the power amplifier 2. The transformers 16 and 16-1 to 16-3 are disposed one for every one channel. The resistors 17 and 17-1 to 17-3 of the transformers 16 and 16-1 to 16-3 are adjusted such that the output impedance between the deck 7 and the power amplifier 2 can be matched with the input impedance and such that the output level of the deck 7 can be matched with the input level of the power amplifier 2. Thus, the above-described arrangement can ensure the level conversion and low signal source impedance suitable for use of a commercially available deck with an integrated power amplifier although the arrangement is simple. Consequently, the genuine head unit can be replaced by the commercially available non-genuine deck in the super live sound system serving as the vehicle audio system. Furthermore, the adapter can be used with latest audio equipment such as CD and MD. Additionally, the adapter can provide presence or realism in the super live sound system with the use of a genuine power amplifier.

The foregoing description and drawing are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

We claim:

1. An audio adapter used with a vehicle audio system including a power amplifier, a head unit serving as a tuner, and a plurality of loud speakers provided in a vehicle compartment, the audio adapter comprising a transformer provided for every one channel between a non-genuine head unit and the power amplifier when the head unit is replaced by the non-genuine head unit, the transformer matching an output impedance with an input impedance between the non-genuine head unit and the power amplifier, the transformer adjusting an output level of the non-genuine head unit to an input level of the power amplifier.

2. An audio adapter according to claim 1, wherein the loud speakers include first and second loud speakers including respective transformers having respective secondary windings connected in series or parallel with each other, and which further comprises an electric circuit for generating a mixed signal of a first loud speaker signal and a second loud speaker signal by connecting the secondary windings of the transformers of the first and second loud speakers in series or parallel with each other so that a center speaker signal and a woofer signal are generated.

3. An audio adapter according to claim 1, wherein the loud speakers include a first loud speaker and a second loud speaker, and which further comprises a transformer having a primary side including two windings and a secondary side including one winding, the two windings of the primary side serving as transformer inputs of the first and second loud speakers respectively, the winding of the secondary side serving as a mixed signal output of first and second loud speaker signals.

4. An audio adapter according to claim 2, wherein the loud speakers include a first loud speaker and a second loud speaker, and which further comprises a transformer having a primary side including two windings and a secondary side including one winding, the two windings of the primary side serving as transformer inputs of the first and second loud speakers respectively, the winding of the secondary side serving as a mixed signal output of first and second loud speaker signals.
